(19) United States
(12) Patent Application Publication
(10) Pub. No.: US 2008/0017610 A1
(43) Pub. Date: Jan. 24, 2008

(54) PROCESS FOR PRODUCING GLASS SUBSTRATE FOR MAGNETIC DISK

(75) Inventors: Kazuo MANNAMI, Chiyoda-ku (JP); Masabumi Ito, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 11/775,634

(22) Filed: Jul. 10, 2007

(30) Foreign Application Priority Data
Jul. 18, 2006 (JP) 2006-195633

(51) Int. Cl. C03C 15/00

(52) U.S. Cl. 216/52

(57) ABSTRACT

A process for producing a glass substrate for a magnetic disk, which comprises etching an edge surface of circular glass, followed by polishing.

The present invention relates to a process for producing a glass substrate for a magnetic disk (hereinafter sometimes referred to as a “glass substrate”).

Heretofore, as a disk-shape magnetic disk to be used for e.g. magnetic disk memory devices, an aluminum alloy substrate has been mainly employed. However, along with the demand for high density recording, a glass substrate has now been used which is hard as compared with an aluminum alloy substrate and which is excellent in flatness and smoothness.

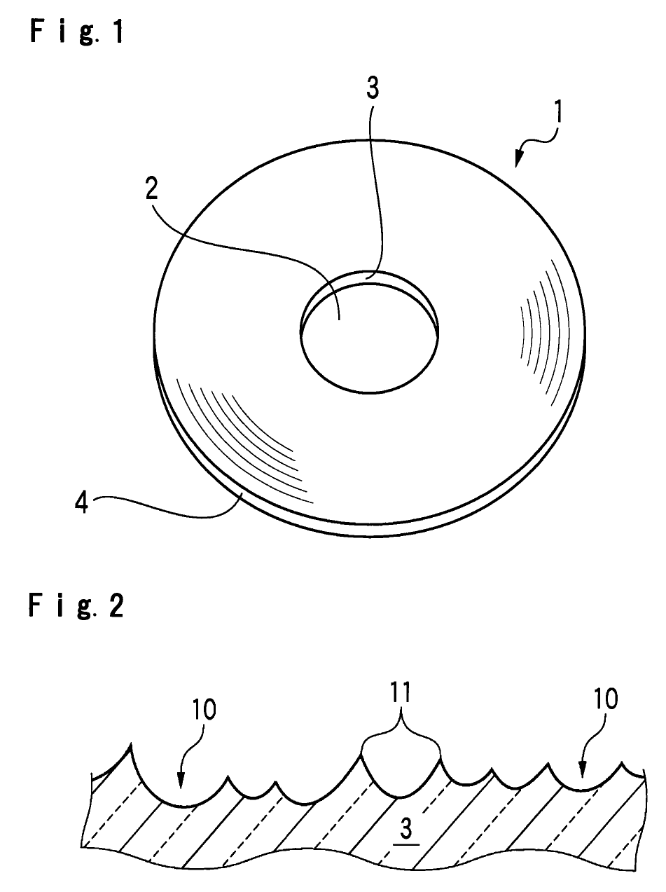

As schematically shown in FIG. 1, a glass substrate 1 has a doughnut shape having a circular hole 2 at its center and becomes a magnetic disk after a magnetic layer (not shown) is formed on its flat surface. A magnetic layer is formed usually by sputtering in a coating apparatus (sputtering apparatus) in which an outer peripheral edge surface 4 of the glass substrate 1 is supported. When the glass substrate 1 is fitted into the sputtering apparatus, it is common to hold the glass substrate 1 by the circular hole 2. In a magnetic disk memory device, to increase read/write precision along with high density recording, the distance between the recording surface of a magnetic disk and a magnetic head is becoming very narrow, and accordingly flatness of the recording surface is particularly important, and high level of cleaning environment is essential in a step of forming a magnetic layer.

Further, also when a magnetic disk is fitted into or taken out from a magnetic disk memory device, a spindle shaft of the magnetic disk memory device and the circular hole 2 of the glass substrate 1 will come in contact with each other to send glass dust flying, and if the glass dust is attached to the recording surface, normal read/write will not be conducted.

Accordingly, various countermeasures are taken on the glass substrate 1 to suppress formation of glass dust from an inner peripheral edge surface 3 of the circular hole 2 to be in contact with a spindle shaft of the coating apparatus.

For example, the glass substrate 1 is produced commonly by cutting a glass plate into a doughnut shape and subjecting an inner peripheral edge surface 3 and an outer peripheral edge surface 4 to chamfering and finish polishing with abrasive grains, but many fine scars remain by the finish polishing. Therefore, it has been proposed to eliminate the remaining fine scars by an etching liquid after the finish polishing and to define the sizes (curvature radii) of the remaining pits (Japanese Patent Application No. 2004-363495).

However, even after the etching treatment, overlapping pits 10 remain as ridges 11, which keenly protrude, as schematically shown in FIG. 2. Thus, when the ridges come in contact with a spindle shaft, they will easily be broken to form glass dust.

Therefore, the etching treatment alone will be insufficient to suppress formation of glass dust. Thus, the present invention is to provide a process for producing a glass substrate for a magnetic disk capable of further suppressing formation of glass dust.

To accomplish the above object, the present invention provides the following process for producing a glass substrate for a magnetic disk.

(1) A process for producing a glass substrate for a magnetic disk, which comprises etching an edge surface of circular glass, followed by polishing.

(2) The process for producing a glass substrate for a magnetic disk according to the above (1), wherein second etching is carried out after the polishing.

(3) The process for producing a glass substrate for a magnetic disk according to the above (1) or (2), wherein as the polishing, at least one of brush polishing, sponge polishing, polishing with a viscous fluid, polishing with a magnetic fluid and polishing with a sponge abrasive, is carried out.

According to the present invention, polishing is carried out after etching treatment to abrade ridges between pits remaining after the etching treatment, whereby formation of glass dust can be significantly suppressed as compared with the case of etching treatment alone. Therefore, by use of a glass substrate obtainable by the present invention, adhesion of glass dust to a surface to be coated with a magnetic material in production of a magnetic disk will be smaller, and the yield will remarkably improve. Further, also when a magnetic disk is fitted into or taken out from a magnetic disk memory device, flying and adhesion of glass dust to the recording surface will reduce or will not occur, whereby read/write will stably be carried out.

In the accompanying drawings:

FIG. 1 is a view schematically illustrating one example of a glass substrate for a magnetic disk.

FIG. 2 is a view schematically illustrating the cross-section after etching.

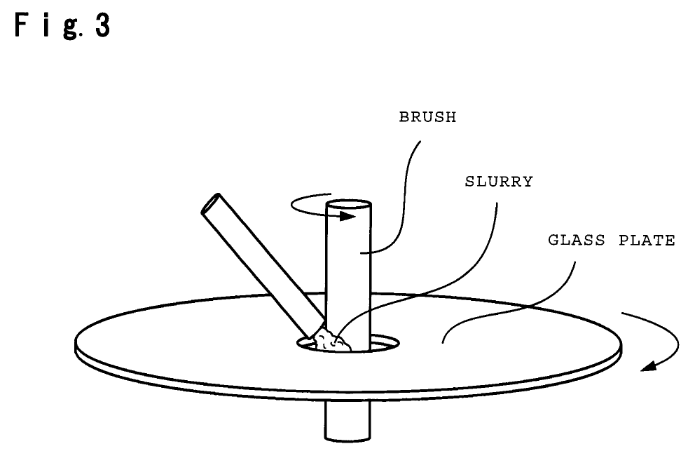

FIG. 3 is a view schematically illustrating a polishing method.

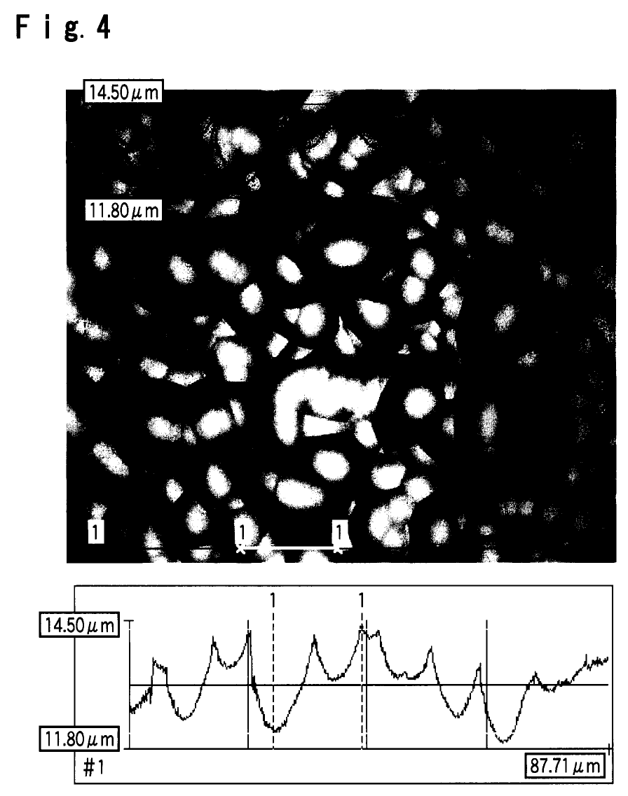

FIG. 4 is a laser microscope photograph of an inner peripheral edge surface after etching in Example 1.

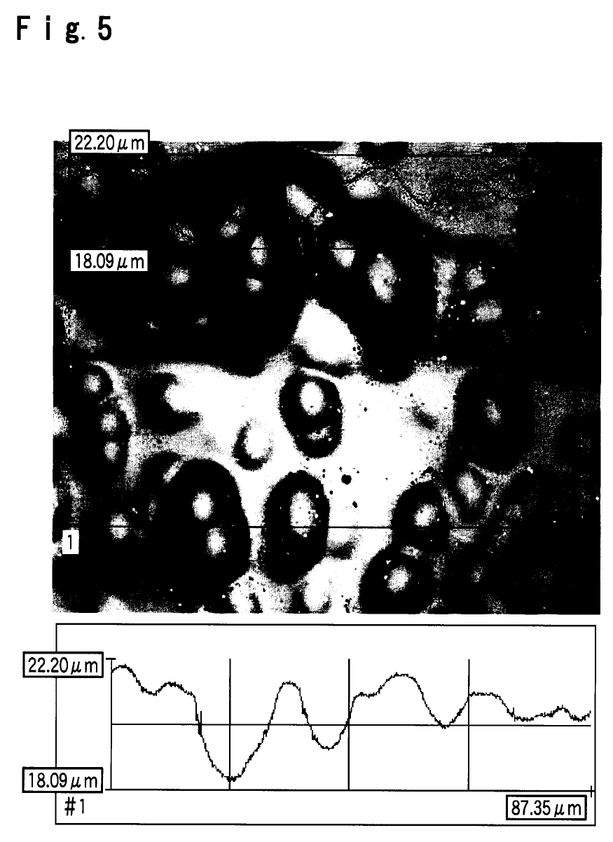

FIG. 5 is a laser microscope photograph of an inner peripheral edge surface subjected to polishing with a sponge abrasive after etching.

Now, the process for producing a glass substrate for a magnetic disk of the present invention will be described in detail.

In the present invention, operation until the etching treatment will be carried out, for example, as follows. Namely, specifically, a glass plate is cut into a doughnut-shape glass plate, and grinding of the inner and outer peripheral edge surfaces, lapping of the upper and lower planes, mirror polishing of the outer peripheral edge surface and the etching treatment are sequentially carried out. Each treatment may be carried out under conventional conditions, and one example is described below.

A doughnut-shape glass plate having predetermined outer diameter and inner diameter is cut out from a silicate glass plate formed by float process to prepare a glass plate having a circular hole at its center (see FIG. 1). The thickness of the glass plate is usually from about 0.38 to about 1.2 mm. The glass composition is not limited so long as the glass plate has mechanical strength as a glass plate for a magnetic disk, but glass containing alkali metal oxides in a total content of from 0 to 20 mass % (e.g. soda lime silica glass having a total content of alkali metal oxides of about 13 mass %), alumina silicate glass, alkali free glass or crystallized glass may, for example, be mentioned. Further, glass having the following properties is preferred with a view to improving weather resistance.

Water resistance: When the glass is immersed in water of 80° C. for 24 hours, the weight reduction of the glass (eluted amount) due to elution of components from the glass, is not more than 0.02 mg/cm³.

Acid resistance: When the glass is immersed in a 0.1 N hydrochloric acid aqueous solution of 80° C. for 24 hours, the weight reduction of the glass (eluted amount) due to elution of components from the glass, is not more than 0.06 mg/cm³.

Alkali resistance: When the glass is immersed in a 0.1 N sodium hydroxide aqueous solution of 80° C. for 24 hours, the weight reduction of the glass (eluted amount) due to elution of components from the glass is not more than 1 mg/cm³, more preferably not more than 0.18 mg/cm³.

Further, the glass plate has a brittleness index (B) of preferably at least 5,500 m^{-1/2}, more preferably at least 7,000 m^{-1/2}. The brittleness index is an index to quantitatively evaluate brittleness from the relation between the size of a trace of a Vickers indenter left on a glass surface after the indenter is pressed against the glass, and the length of cracks generated at four corners of the trace, and is B calculated from the following formula, where P is a pressing load of the Vickers indenter, “a” is the width across corner of the Vickers trace and “c” is the length of cracks generated at four corners of the Vickers trace (the total length of symmetric two cracks including the trace of the indenter) (see JP-A-10-152338):

c/a=0.0056×B^{2/3}×P^{1/6}

Then, the inner and outer peripheral edge surfaces of the glass plate are ground by diamond abrasive grains. The diamond abrasive grains are preferably abrasive grains finer than #800 mesh.

Then, the inner and outer peripheral edge surfaces are chamfered with an angle of chamfer of 45°.

Then, the upper and lower planes of the glass plate are subjected to lapping. Lapping is carried out by alumina abrasive grains or metal oxide abrasive grains having an average particle size of from 6 to 8 μm.

Then, mirror finish processing is applied to the outer peripheral edge surface by brush polishing using a cerium oxide slurry as a polishing compound and using a brush as a polishing tool. Cerium oxide as the polishing compound is preferably a #200 to #1000 mesh product. The polishing amount is suitably, for example, about 30 μm by the removed amount in the radius direction. It is preferred that the surface roughness (Ra) is at most 1.0 μm, more preferably at most 0.7 μm after the mirror finish processing.

Then, etching treatment is applied to the inner peripheral edge surface. For the etching treatment, either wet etching by means of an etching liquid or dry etching by means of an etching gas is employed, but preferred is wet etching by means of an etching liquid such as a hydrofluoric acid solution, a hydrofluoric sulfuric acid solution, a hydrofluoric nitric acid solution or a silicofluoric acid solution, and more preferred is wet etching by means of a hydrofluoric sulfuric acid solution or a hydrofluoric nitric acid solution. The etching amount is preferably at least 2.5 μm, more preferably at least 5.0 μm. If the etching amount is smaller than 2.5 μm, many small pits will remain, and ridges formed between small pits are difficult to remove even by the after-mentioned polishing treatment.

After the above steps, in the present invention, polishing treatment is applied to the inner peripheral edge surface. As a polishing method, preferred is brush polishing, sponge polishing, polishing with a viscous fluid, polishing with a magnetic fluid or polishing with a sponge abrasive. These polishing methods may be carried out alone or in a proper combination. Further, the glass plates may be polished one by one or a plurality of the glass plates may be overlaid and polished all at once.

The brush polishing is carrying out preferably by a slurry containing cerium oxide having an average particle size of from 0.1 to 5 μm, typically from 0.5 to 1.8 μm and by a resin brush. Polishing is carried out, as schematically shown in FIG. 3, by inserting a cylindrical brush into a circular hole of the glass plate and supplying the slurry to a space between the inner peripheral edge surface of the glass plate and the brush while rotating the brush and the glass plate, and this polishing is continued for a predetermined time.

The sponge polishing is carried out preferably by a slurry containing cerium oxide having an average particle size of from 0.1 to 5 μm, typically from 0.5 to 1.8 μm and by a urethane sponge. This sponge polishing is carried out by a polishing apparatus having a structure shown in FIG. 3 wherein a sponge is used instead of the brush.

The polishing with a viscous fluid is carried out preferably by a slurry containing cerium oxide having an average particle size of from 0.1 to 5 μm, typically from 0.5 to 1.8 μm and a thickener such as polyacrylic acid, ethylene glycol, glycerol, polyvinyl alcohol, sodium carboxymethyl cellulose, galactomannan or methylated polygalacturonic acid and having a viscosity of at least 0.01 Pa·s. This polishing with a viscous fluid can be carried out by a polishing apparatus having a structure shown in FIG. 3.

The polishing with a magnetic fluid is carried out preferably by a mixed slurry of cerium oxide having an average particle size of from 0.1 to 5 μm, typically from 0.5 to 1.8 μm and a magnetic powder. This polishing with a magnetic fluid can be carried out by a polishing apparatus having a structure shown in FIG. 3. Further, a slurry for the polishing with a viscous fluid may be used in combination.

The polishing with a sponge abrasive is carried out preferably by a sponge abrasive made of an urethane foam with which any of cerium oxide having an average particle size of from 0.1 to 5 μm, typically from 0.5 to 1.8 μm, aluminum oxide, magnesium oxide and calcium carbonate is mixed. This polishing with a sponge abrasive can be carried out by a polishing apparatus having a structure shown in FIG. 3 wherein a sponge abrasive is used instead of the brush. Further, a slurry for the polishing with a viscous fluid may be used in combination.

By such polishing treatment, the ridges formed by the etching treatment will be abraded, thus suppressing formation of glass dust when they come in contact with a spindle shaft.

Further, etching treatment may be carried out again after the above polishing treatment. By such etching treatment, edges of the ridges generated by abrasion will be eliminated, whereby formation of glass dust can be further suppressed.

Then, polishing is applied to principal planes. This polishing is carried out preferably by a slurry containing cerium oxide having an average particle size of from 0.9 to 1.8 μm and by a urethane polishing pad. The loss of the plate thickness (removed amount) is suitably, for example, from 30 to 40 μm. Then, polishing is carried out by, as a polishing compound, cerium oxide having an average particle size smaller than that of the above cerium oxide, for example, having an average particle size of from 0.15 to 0.25 μm, and by a urethane pad as a polishing tool. The removed amount is suitably, for example, about 1.6 μm.

Magnetic disk memory disks include one which holds a magnetic disk by the outer peripheral edge surface. With respect to a glass substrate for a magnetic disk to be used for such a magnetic disk memory device, the above etching treatment and polishing treatment are applied similarly to the outer peripheral edge surface of a glass plate.

Now, the present invention will be described in further detail with reference to an Example.

### EXAMPLE 1

A doughnut-shape circular glass plate having an outer diameter of 65 mm and an inner diameter of 20 mm was prepared from a silicate glass plate having a thickness of 0.9 mm formed by float process (as calculated as oxides, SiO₂: 66 mass %, Al₂O₃: 5 mass %, Fe₂O₃: 0.04 mass %, Na₂O: 5 mass %, K₂O: 4 mass %, MgO: 3 mass %, CaO: 6 mass %, BaO: 4 mass %, SrO: 5 mass % and ZrO₂: 2 mass %). The inner and outer peripheral edge surfaces of the glass plate were ground with diamond abrasive grains and chamfered with a chamfer width of 0.15 mm and an angle of chamfer of 45°.

Then, the upper and lower planes were lapped by a slurry containing aluminum oxide abrasive grains and a platen made of cast iron so that the plate thickness was 0.670 mm.

Then, mirror finish processing was applied to the outer peripheral edge surface by using a cerium oxide slurry as a polishing compound and by using a brush as a polishing tool. The processing amount was 30 μm by the removed amount in the radius direction.

Then, the glass plate was immersed in a hydrofluoric nitric acid solution containing 5% hydrofluoric acid and 10% nitric acid for 95 seconds to apply etching treatment to the inner peripheral edge surface. The etching amount was about 20 μm. Further, the inner peripheral edge surface was photographed by VIOLET LASER (VK-9500) apparatus (manufactured by KEYENCE CORPORATION). The resulting photograph is shown in FIG. 4, with a profile of an optional cross-section on the photographed area. As shown in FIG. 4, overlapping pits form keen ridges.

Then, the inner peripheral edge surface of the glass plate was polished by a slurry containing cerium oxide having an average particle size of from 0.5 to 1.8 μm and by a urethane sponge (see FIG. 3). Polishing was carried out at a number of revolutions of the urethane sponge of 100 rpm at a number of revolutions of the glass plate of 30 rpm for 5 minutes, and the inner peripheral edge surface after the polishing was photographed by VIOLET LASER (VK-9500) apparatus (manufactured by KEYENCE CORPORATION). The resulting photograph is shown in FIG. 5, with a profile of an optional cross-section on the photographed area. As shown in FIG. 5, small pits are eliminated, and ridges formed by remaining large pits have round edges. The arithmetical mean roughness (Ra) was at most 1 μm, the maximum height (Rz) was at most 10 μm, the curvature radii of the pits were at least 0.5 μm, and the curvature radii of the ridges were at least 0.5 μm, as observed by a laser microscope.

Then, the upper and lower planes were polished by a double side polisher by a cerium oxide slurry (cerium oxide average particle size: about 1.1 μm) as a polishing compound and by a urethane pad as a polishing tool. The processing amount was 35 μm in total in the direction of the thickness between the upper and lower planes. Further, the upper and lower planes were polished by a double side polisher by cerium oxide having an average particle size of about 0.2 μm as a polishing compound and by a urethane pad as a polishing tool. The processing amount was 1.6 μm in total in the direction of the thickness between the upper and lower planes.

Then, the glass plate was cleaned to obtain a glass substrate for a magnetic disk.

The entire disclosure of Japanese Patent Application No. 2006-195633 filed on Jul. 18, 2006 including specification, claims, drawings and summary is incorporated herein by reference in its entirety.

What is claimed is:

1. A process for producing a glass substrate for a magnetic disk, which comprises etching an edge surface of circular glass, followed by polishing.

2. The process for producing a glass substrate for a magnetic disk according to claim 1, wherein second etching is carried out after the polishing.

3. The process for producing a glass substrate for a magnetic disk according to claim 1, wherein as the polishing, at least one of brush polishing, sponge polishing, polishing with a viscous fluid, polishing with a magnetic fluid and polishing with a sponge abrasive, is carried out.
